(19) United States
(12) Patent Application Publication
(10) Pub. No.: US 2023/0275390 A1
(43) Pub. Date: Aug. 31, 2023

(54) MULTI-CORE FIBER MODULE AND MULTI-CORE FIBER AMPLIFIER

(71) Applicant: SUMITOMO ELECTRIC INDUSTRIES, LTD., Osaka-shi, Osaka (JP)

(72) Inventor: Takafumi OHTSUKA, Osaka-shi (JP)

(73) Assignee: SUMITOMO ELECTRIC INDUSTRIES, LTD., Osaka-shi, Osaka (JP)

(21) Appl. No.: 18/016,885

(22) PCT Filed: Jun. 18, 2021
(86) PCT No.: PCT/JP2021/023217

§ 371 Date: Jan. 19, 2023

(30) Foreign Application Priority Data
Jul. 22, 2020 (JP) 2020-125668

(51) Int. Cl. H01S 3/067; G02B 6/32

(52) U.S. Cl. CPC H01S 3/06729; G02B 6/32

(57) ABSTRACT

A multi-core fiber module includes a transmission MCF configured to be used as a transmission path for an optical signal, a connection MCF having a core arrangement similar to a core arrangement of a core of the transmission MCF, and a relay lens system interposed between the transmission MCF and the connection MCF. A relay magnification of the relay lens system is equal to a ratio of a core interval of the connection MCF to a core interval of the transmission MCF. A core at a leading end surface of the connection MCF is expanded such that a ratio between the core interval and a mode field diameter of the connection MCF is equal to a ratio between the core interval and a mode field diameter of the transmission MCF.

### TECHNICAL FIELD

The present disclosure relates to a multi-core fiber module and a multi-core fiber amplifier.

This application claims priority based on Japanese Patent Application No. 2020-125668 filed on Jul. 22, 2020, the entire contents of which are incorporated herein by reference.

### BACKGROUND ART

PTL 1 describes a configuration in which light passing through a transmission multi-core optical fiber (MCF) and a multi-core optical amplifier arranged in a transmission section is decomposed into a plurality of single-core optical fibers (SCFs) by fan-in and fan-out.

PTL 2 describes a technique in which a connection loss between a pair of optical fibers having different mode field diameters (MFDs) is reduced by a thermal expanded core (TEC). In the technique described in PTL 2, a cladding excitation method is employed.

PTL 3 describes a technique for increasing the core diameter of a multi-core erbium doped optical fiber (MC-EDF) and reducing the mismatch of the MFD with a transmission MCF.

### PRIOR ART DOCUMENT

### Patent Literature

PTL 1: K. Takeshima, et al, “51.1-Tbit/s MCF Transmission Over 2520 km Using Cladding-Pumped Seven-Core EDFAs,” Journal of Light. Technol. 34 (2016), 761

PTL 2: Japanese Unexamined Patent Application Publication No. 2003-98378

PTL 3: M. Wada, et al “Full C-band Low Mode Dependent and Flat Gain Amplifier using Cladding Pumped Randomly Coupled 12-core EDF,” ECOC2017, -Th.PDP.A.5

### SUMMARY OF INVENTION

A multi-core fiber module according to an embodiment includes a transmission optical waveguide assembly configured to be used as a transmission path for an optical signal, a connection optical waveguide assembly having a core arrangement similar to a core arrangement of a core of the transmission optical waveguide assembly, and a relay lens system interposed between the transmission optical waveguide assembly and the connection optical waveguide assembly. A relay magnification of the relay lens system is equal to a ratio of a core interval of the connection optical waveguide assembly to a core interval of the transmission optical waveguide assembly. A core at a leading end surface of the connection optical waveguide assembly is expanded such that a ratio between the core interval and a mode field diameter of the connection optical waveguide assembly is equal to a ratio between the core interval and a mode field diameter of the transmission optical waveguide assembly. At least one of the transmission optical waveguide assembly and the connection optical waveguide assembly is a multi-core fiber.

A multi-core fiber module according to another aspect includes a transmission optical waveguide assembly configured to be used as a transmission path for an optical signal, a connection optical waveguide assembly having a core arrangement similar to a core arrangement of a core of the transmission optical waveguide assembly, and a relay lens system interposed between the transmission optical waveguide assembly and the connection optical waveguide assembly. A relay magnification of the relay lens system is equal to a ratio of a core interval of the connection optical waveguide assembly to a core interval of the transmission optical waveguide assembly. A coma aberration on an output side of the relay lens system is non-negative and at least one of the transmission optical waveguide assembly and the connection optical waveguide assembly is a multi-core fiber.

A multi-core fiber amplifier according to an embodiment is a multi-core fiber amplifier includes the multi-core fiber module and a rare-earth element-doped multi-core fiber in which the connection optical waveguide assembly is doped with a rare earth element. The multi-core fiber amplifier includes the transmission optical waveguide assembly that is a first transmission optical waveguide assembly on a signal input side, the transmission optical waveguide assembly that is a second transmission optical waveguide assembly on a signal output side, the multi-core fiber module that is a first multi-core fiber module and the multi-core fiber module that is a second multi-core fiber module. The rare-earth element-doped multi-core fiber is connected to the connection optical waveguide assembly of the first multi-core fiber module and the connection optical waveguide assembly of the second multi-core fiber module. The transmission optical waveguide assembly of the first multi-core fiber module is connected to the first transmission optical waveguide assembly, and the transmission optical waveguide assembly of the second multi-core fiber module is connected to the second transmission optical waveguide assembly.

### BRIEF DESCRIPTION OF DRAWINGS

FIG. 1 is a diagram showing a multi-core fiber module according to one embodiment.

FIG. 2 is a diagram showing a multi-core fiber module in which an outward coma has occurred.

FIG. 3 is a diagram showing a multi-core fiber module in which an inward coma has occurred.

FIG. 4 is a diagram showing a multi-core fiber module according to another embodiment.

FIG. 5 is a diagram showing a multi-core fiber module according to another embodiment.

FIG. 6 is a diagram showing a multi-core fiber module according to another embodiment.

FIG. 7 is a diagram showing a multi-core fiber amplifier according to one embodiment.

FIG. 8 is a diagram showing a multi-core fiber amplifier according to another embodiment.

FIG. 9 is a diagram showing a multi-core fiber module according to a modification.

FIG. 10 is a diagram showing a multi-core fiber module according to a modification.

FIG. 11 is a diagram showing a multi-core fiber module according to a modification.

FIG. 12 is a diagram showing a multi-core fiber module according to a modification.

FIG. 13 is a diagram showing a multi-core fiber module according to a modification.

FIG. 14 is a graph showing an example of the relationship between a heating time and an MFD of a multi-core fiber.

FIG. 15 is a graph showing the relationship between a refractive index and a coma coefficient of a plano-convex lens in the case where a parallel light is emitted from a plane.

FIG. 16 is a graph showing the relationship between the refractive index and the coma coefficient of a plano-convex lens in the case where parallel light is incident on a plane.

FIG. 17 is a diagram showing various examples of ray of light when coma aberration occurs.

### DESCRIPTION OF EMBODIMENTS

The transmission MCF for signal transmission has a relatively large mode field diameter (hereinafter may be referred to as MFD) (9 to 11 μm) in order to suppress loss or nonlinearity. On the other hand, in the MC-EDF, the MFD is relatively small (6 μm or less) in order to increase the excitation efficiency and the amplification efficiency. As described above, the transmission MCF and the MC-EDF have different MFDs. Therefore, when the transmission MCF is directly connected to the MC-EDF or an MCF having the same core arrangement with the MC-EDF (hereinafter may be referred to as a connection MCF), a connection loss of light may occur due to mismatching of the MFDs.

By the way, even when the TEC process is performed as in the PTL 2 described above, the MFDs of the transmission MCF and the MC-EDF or the connection MCF may not match each other due to a difference between the refractive index distribution of the transmission MCF and the refractive index distribution of the MC-EDF or the connection MCF. Furthermore, in order to match the MFDs, matching of the core interval may also be required. Therefore, even when the TEC process is performed, it may be difficult to obtain the effect of reducing the connection loss. Since the MFD of the MC-EDF or the connection MCF used inside the optical amplifier is small, end face reflection may occur in an optical module that performs spatial coupling by a lens system such as an optical isolator. Furthermore, since the utilization efficiency of the excitation light may be low when the cladding excitation method is employed as in the PTL 2 described above, there is room for improvement in the utilization efficiency of the excitation light.

An object of the present disclosure is to provide a multi-core fiber module and a multi-core fiber amplifier capable of reducing connection loss of light.

According to the present disclosure, the connection loss of light can be reduced.

### DESCRIPTION OF EMBODIMENTS OF PRESENT DISCLOSURE

Embodiments of the present disclosure are listed below. A multi-core fiber module according to an embodiment includes a transmission optical waveguide assembly configured to be used as a transmission path for an optical signal, a connection optical waveguide assembly having a core arrangement similar to a core arrangement of a core of the transmission optical waveguide assembly, and a relay lens system interposed between the transmission optical waveguide assembly and the connection optical waveguide assembly. A relay magnification of the relay lens system is equal to a ratio of a core interval of the connection optical waveguide assembly to a core interval of the transmission optical waveguide assembly. A core at a leading end surface of the connection optical waveguide assembly is expanded such that a ratio between the core interval and a mode field diameter of the connection optical waveguide assembly is equal to a ratio between the core interval and a mode field diameter of the transmission optical waveguide assembly. At least one of the transmission optical waveguide assembly and the connection optical waveguide assembly is a multi-core fiber.

In this multi-core fiber module, the core arrangement of the transmission optical waveguide assembly is similar to the core arrangement of the connection optical waveguide assembly connected to the transmission optical waveguide assembly via the relay lens system. The relay magnification of the relay lens system is equal to the ratio of the core interval of the connection optical waveguide assembly to the core interval of the transmission optical waveguide assembly. The core at a leading end surface of the connection optical waveguide assembly is expanded such that a ratio between the core interval and a mode field diameter of the connection optical waveguide assembly is equal to a ratio between the core interval and a mode field diameter of the transmission optical waveguide assembly. Therefore, the ratio between the core interval and the mode field diameter is matched between the transmission optical waveguide assembly and the connection optical waveguide assembly, and the ratio between the core interval of the transmission optical waveguide assembly and the core interval of the connection optical waveguide assembly is equal to the relay magnification. Therefore, it is possible to connect the transmission optical waveguide assembly and the connection optical waveguide assembly with low loss via the relay lens system.

Both the transmission optical waveguide assembly and the connection optical waveguide assembly may be multi-core fibers.

The relay magnification may be 0.5 times or more and 2.0 times or less. In this case, since the relay magnification is 0.5 times or more and 2.0 times or less, it is possible to suppress the occurrence of aberration of the relay lens system between the transmission optical waveguide assembly and the connection optical waveguide assembly.

The mode field diameter at a leading end surface of the connection optical waveguide assembly may be 7 μm or more. In this case, since the mode field diameter at the leading end surface of the connection optical waveguide assembly is 7 μm or more, the connection loss due to reflection of light at the leading end surface can be more reliably suppressed.

A coma aberration on an output side of the relay lens system may be non-negative. In this case, even though a coma aberration occurs on the output side of the relay lens system, the coma aberration can be directed outward. Therefore, optical coupling to an adjacent core can be avoided, and occurrence of excessive crosstalk can be suppressed.

The relay lens system may include an input-side lens and an output-side lens. A refractive index of the input-side lens may be 1.68 or more, and a radius of curvature of an incidence surface of the input-side lens may be 10 times or more of a radius of curvature of an exit surface of the input-side lens. One of the transmission optical waveguide assembly and the connection optical waveguide assembly may be an input-side optical waveguide assembly, and another one of the transmission optical waveguide assembly and the connection optical waveguide assembly may be an output optical waveguide assembly, and the input-side optical waveguide assembly may be disposed such that a distance between a light exit end of the input-side optical waveguide assembly and a principal point of the input-side lens is 0.99 times or more and 1.01 times or less of a focal distance of the input-side lens. A refractive index of the output-side lens may be 1.70 or less, and a radius of curvature of an exit surface of the output-side lens may be 10 times or more of a radius of curvature of an incidence surface of the output-side lens. The output optical waveguide assembly may be disposed such that a distance between a light incidence end of the output optical waveguide assembly and a principal point of the output-side lens is 0.99 times or more and 1.01 times or less of a focal distance of the output-side lens. In this case, coma aberration may be directed outward in the relay lens system including a plano-convex lens.

The relay lens system may include an input-side lens and an output-side lens, a refractive index of the input-side lens may be 1.62 or more, and a radius of curvature of an incidence surface of the input-side lens may be 10 times or more of a radius of curvature of an exit surface of the input-side lens. One of the transmission optical waveguide assembly and the connection optical waveguide assembly may be an input-side optical waveguide assembly, and another one of the transmission optical waveguide assembly and the connection optical waveguide assembly may be an output optical waveguide assembly, and the input-side optical waveguide assembly may be disposed such that a distance between a light exit end of the input-side optical waveguide assembly and a principal point of the input-side lens is 0.99 times or more and 1.01 times or less of a focal distance of the input-side lens. A refractive index of the output-side lens may be 1.51 or less, and a radius of curvature of an exit surface of the output-side lens may be 10 times or more of a radius of curvature of an incidence surface of the output-side lens. The output optical waveguide assembly may be disposed such that a distance between a light incidence end of the output optical waveguide assembly and a principal point of the output-side lens is 0.99 times or more and 1.01 times or less of a focal distance of the output-side lens. In this case, coma aberration may be directed outward in a relay lens system including a plano-convex lens.

A multi-core fiber module according to another aspect includes a transmission optical waveguide assembly configured to be used as a transmission path for an optical signal, a connection optical waveguide assembly having a core arrangement similar to a core arrangement of a core of the transmission optical waveguide assembly, and a relay lens system interposed between the transmission optical waveguide assembly and the connection optical waveguide assembly. A relay magnification of the relay lens system is equal to a ratio of a core interval of the connection optical waveguide assembly to a core interval of the transmission optical waveguide assembly. A coma aberration on an output side of the relay lens system is non-negative, and at least one of the transmission optical waveguide assembly and the connection optical waveguide assembly is a multi-core fiber. In this case, even though coma aberration occurs on the output side of the relay lens system, coma aberration can be directed outward. Therefore, optical coupling to an adjacent core can be avoided, and occurrence of excessive crosstalk can be suppressed.

A core at a leading end surface of an optical waveguide of at least one of the transmission optical waveguide assembly and the connection optical waveguide assembly may be expanded. In this case, mismatching of the mode field diameter can be suppressed.

The transmission optical waveguide assembly and the connection optical waveguide assembly may be multi-core fibers of types identical to each other. The transmission optical waveguide assembly and the connection optical waveguide assembly may be multi-core fibers of types differing from each other. One of the transmission optical waveguide assembly and the connection optical waveguide assembly may be an assembly of single-core fibers. At least one of the transmission optical waveguide assembly and the connection optical waveguide assembly may be an assembly of multi-core fibers.

A multi-core fiber amplifier according to an embodiment is a multi-core fiber amplifier includes the multi-core fiber module described above and a rare-earth element-doped multi-core fiber in which the connection optical waveguide assembly is doped with a rare earth element. The multi-core fiber amplifier includes a first transmission optical waveguide assembly on a signal input side, a second transmission optical waveguide assembly on a signal output side, a first multi-core fiber module, and a second multi-core fiber module. The rare-earth element-doped multi-core fiber is connected to the connection optical waveguide assembly of the first multi-core fiber module and the connection optical waveguide assembly of the second multi-core fiber module. The transmission optical waveguide assembly of the first multi-core fiber module is connected to the first transmission optical waveguide assembly, and the transmission optical waveguide assembly of the second multi-core fiber module is connected to the second transmission optical waveguide assembly.

The multi-core fiber amplifier includes the first and second multi-core fiber modules described above and the rare-earth element-doped multi-core fiber. The rare-earth element-doped multi-core fiber is connected to the connection optical waveguide assembly of the first multi-core fiber module and the connection optical waveguide assembly of the second multi-core fiber module. The transmission optical waveguide assembly of the first multi-core fiber module is connected to the first transmission optical waveguide assembly of the signal input side, and the transmission optical waveguide assembly of the second multi-core fiber module is connected to the second transmission optical waveguide assembly of the signal output side. The core interval and the mode field diameter are matched between each transmission optical waveguide assembly and each connection optical waveguide assembly, and the ratio of the core interval between each transmission optical waveguide assembly and each connection optical waveguide assembly is equal to the relay magnification. Therefore, the mode field diameters of the transmission optical waveguide assembly and the rare-earth element-doped multi-core fiber can be matched.

The first multi-core fiber module may include an excitation light combiner, and the second multi-core fiber module may include an optical isolator. In this case, since the core interval and the mode field diameter of each multi-core fiber are matched, it is possible to reduce the end face reflection in the optical connection through the rare-earth element-doped multi-core fiber having a small mode field diameter or the connection optical waveguide assembly. Thus, the utilization efficiency of the excitation light can be enhanced.

### Details of Embodiments of Present Disclosure

Specific examples of a multi-core fiber module and a multi-core fiber amplifier according to an embodiments of the present disclosure will be described. In the description of the drawings, the same or corresponding elements are denoted by the same reference numerals, and redundant description is omitted as appropriate. The drawings may be partially simplified or exaggerated for ease of understanding, and dimensional ratios and the like are not limited to those illustrated in the drawings.

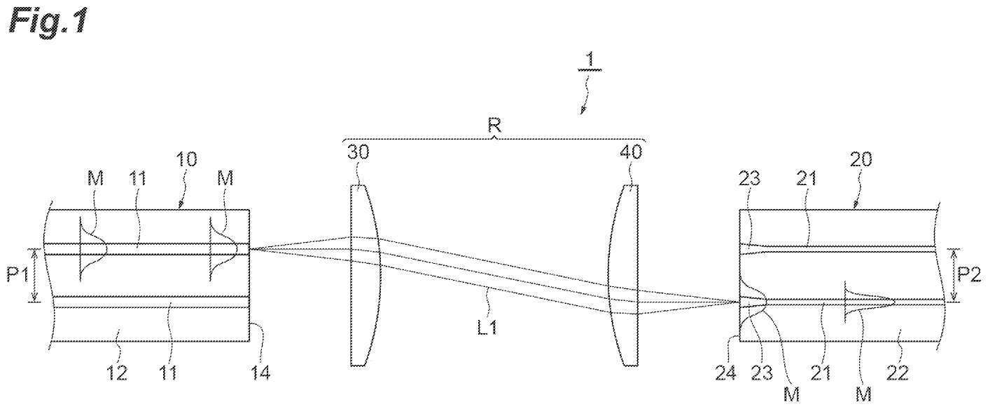

FIG. 1 is a diagram showing a multi-core fiber module 1 according to an embodiment. In the following description, the multi-core fiber may be referred to as MCF, and the mode field diameter may be referred to as MFD. Multi-core fiber module 1 includes a transmission MCF 10, which is an example of a transmission optical waveguide assembly, and a connection MCF 20, which is an example of a connection optical waveguide assembly. In this embodiment, multi-core fiber module 1 includes transmission MCF 10, connection MCF 20, and a relay lens system R interposed between transmission MCF 10 and connection MCF 20. Transmission MCF 10 is used as a transmission path of a light L1 which is an optical signal. Transmission MCF 10 includes a plurality of (for example, seven) cores 11 and a cladding 12. Connection MCF 20 includes a plurality of (for example, seven) cores 21 and a cladding 22. Connection MCF 20 has a core arrangement similar to cores 11 of transmission MCF 10.

For example, multi-core fiber module 1 inputs light L1 to an optical amplifier through transmission MCF 10, relay lens system R, and connection MCF 20. In this case, transmission MCF 10 is an input-side optical waveguide assembly and connection MCF 20 is an output optical waveguide assembly. Relay lens system R includes, for example, a first lens 30 which is an input-side lens facing a leading end surface 14 of transmission MCF 10 and a second lens 40 which is an output-side lens facing a leading end surface 24 of connection MCF 20.

For example, an antireflection film is provided on each of leading end surface 14 and leading end surface 24. The normal line of each of leading end surface 14 and leading end surface 24 may be inclined (for example, about 8°) with respect to the direction in which transmission MCF 10 and connection MCF 20 extend. In this case, it is possible to suppress reflection of light L1 on each of leading end surface 14 and leading end surface 24. For example, in multi-core fiber module 1, transmission MCF 10, first lens 30, second lens 40, and connection MCF 20 are arranged in this order. Transmission MCF 10 and connection MCF 20 are optically coupled via a space (spatial coupling).

An arrangement shape of a plurality of cores 11 of transmission MCF 10 and an arrangement shape of a plurality of cores 21 of connection MCF 20 are similar to each other. For example, when a core interval of cores 11 of transmission MCF 10 is P1 (μm) and a core interval of cores 21 of connection MCF 20 is P2 (μm), P1 is equal to P2.

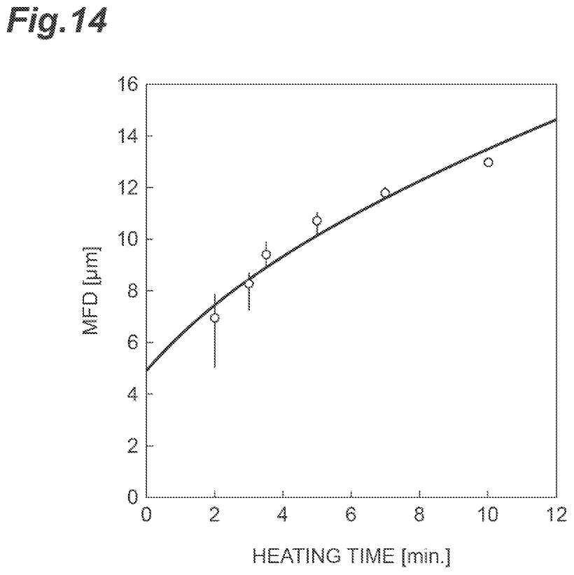

For example, connection MCF 20 has a core expansion portion 23 at leading end surface 24. Core expansion portion 23 denotes a portion where core 21 is expanded. The expansion of core 21 is performed, for example, by heating core 21. As illustrated in FIG. 14, as core 21 is heated, the MFD of connection MCF 20 is expanded.

For example, an MFD at the specific wavelength at an output end of core 11 of transmission MCF 10 is MFD1 (μm), and an MFD of the specific wavelength at an output end of core 21 of connection MCF 20 is MFD2 (μm). At this time, core 21 at leading end surface 24 of connection MCF 20 is expanded so that a ratio between the core interval P2 and the MFD2 of connection MCF 20 is equal to a ratio between the core interval P1 and the MFD1 of transmission MCF 10.

In the present disclosure, the term “equal” is not limited to a case where the values completely coincide with each other, but also includes a case where the values are substantially the same to the extent that there is no functional difference (for example, a case of ±10% or less). The MFD2 of connection MCF 20 in which core 21 is expanded is 7 μm or more and 30 μm or less, for example.

In relay lens system R, for example, first lens 30 converts light L1 emitted from each of the plurality of cores 11 of transmission MCF 10 into collimated light, and second lens 40 condenses light L1 on core 21 of connection MCF 20. When a relay magnification of relay lens system R (for example, first lens 30 and second lens 40) is r, the value of r is equal to the value of (P2/P1), that is, a ratio of core interval P2 of connection MCF 20 to core interval P1 of transmission MCF 10.

FIG. 1 shows an example where MFD1 is equal to MFD2. That is, in multi-core fiber module 1, transmission MCF 10 and connection MCF 20 each having the same core interval are connected to each other through an equal-magnification relay lens system. Optical electric fields in core 11 of transmission MCF 10 and in core 21 of connection MCF 20 are shown as bell-shaped symbols M in FIG. 1. As indicated by the mark M, for example, the optical electric field at leading end surface 24 in core 21 of connection MCF 20 coincides with the optical electric field of core 11 of transmission MCF 10. An expansion ratio of the MFD at leading end surface 24 of connection MCF 20 is, for example, equal to a ratio of the MFD of transmission MCF 10 to the MFD of core 21 which is not subjected to core expansion, and is, for example, about ±10%.

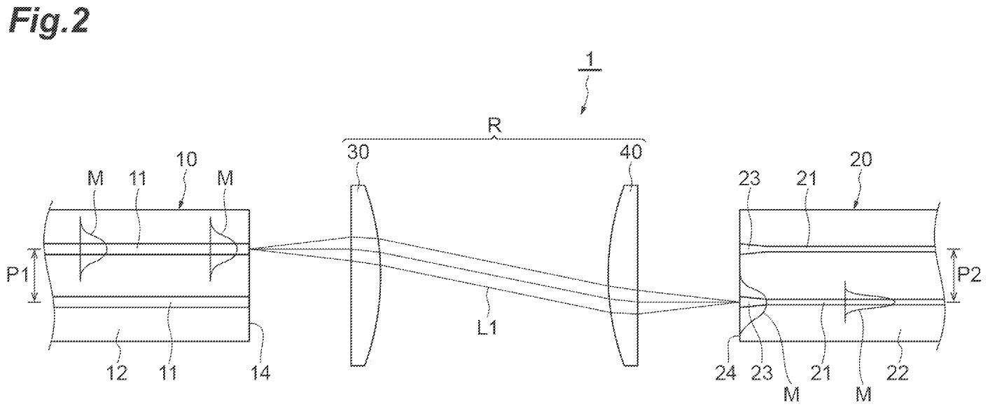

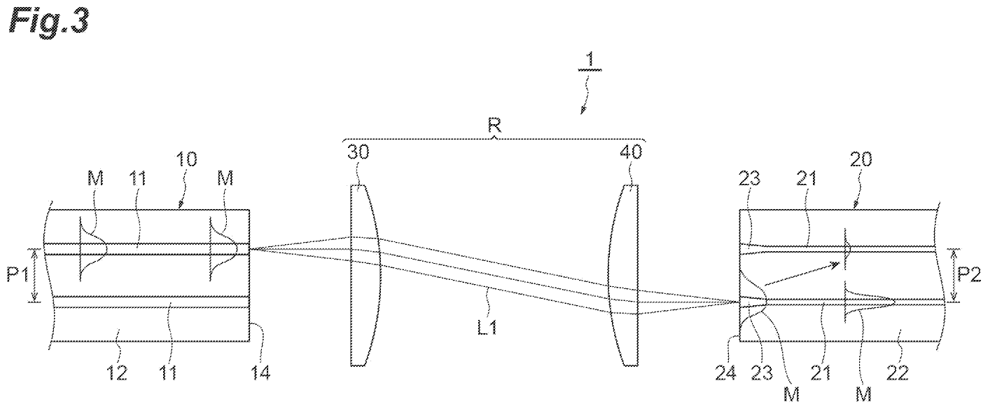

Meanwhile, coma aberration may occur on an output side of relay lens system R. FIG. 2 shows an example in which coma aberration occurs in an outward direction with respect to an optical axis (outward coma aberration), and FIG. 3 shows an example in which coma aberration occurs in an inward direction with respect to the optical axis (inward coma aberration). In a configuration in which the plurality of cores 21 are arranged to form an annular shape in a cross section of connection MCF 20 orthogonal to the optical axis, a spread of the optical electric field due to the inward coma aberration may cause excessive crosstalk between cores 21. When a doublet lens or a triplet lens is used as relay lens system R, coma aberration can be suppressed. However, from the viewpoint of cost reduction, it is preferable to use a singlet lens as relay lens system R. According to the embodiment, first lens 30 and second lens 40 are singlet lenses.

In the embodiment, the singlet lens of relay lens system R is designed such that coma aberration to be outward. Since the optical electric field expanded by the outward coma aberration is not coupled to a waveguide mode of adjacent core 21, it does not cause excessive crosstalk. By making the coma aberration of the output side of relay lens system R non-negative, the coma aberration becomes outward, and the suppression of excessive crosstalk between cores 21 is realized. A refractive index, a shape, and a position of each of first lens 30 and second lens 40 are determined such that coma aberration is outward at leading end surface 24 of connection MCF 20. Examples of the refractive index, the shape, and the position will be described below.

As an example, first lens 30 and second lens 40 are plano-convex lenses. For example, the refractive index of first lens 30 is 1.68 or more (as an example, about 1.69), and a radius of curvature of an incidence surface of first lens 30 is 10 times or more of a radius of curvature of an exit surface of first lens 30. In the embodiment, the value of the refractive index indicates a value in a wavelength band of 1520 nm or more and 1570 nm or less (C band) or 1520 nm or more and 1630 nm or less (C+L band) each of which is a communication wavelength band of the optical fiber. The incidence surface of first lens 30 is substantially planar. A distance between an emitting end of the light L of transmission MCF 10 and a principal point of first lens 30 is 0.99 times or more and 1.01 times or less of a focal distance of first lens 30. The refractive index of second lens 40 is 1.70 or less, and a radius of curvature of an exit surface of second lens 40 is 10 times or more of a radius of curvature of an incidence surface of second lens 40. The exit surface of second lens 40 is substantially planar. A distance between a light incidence end of connection MCF 20 and a principal point of second lens 40 is 0.99 times or more and 1.01 times or less of a focal distance of second lens 40.

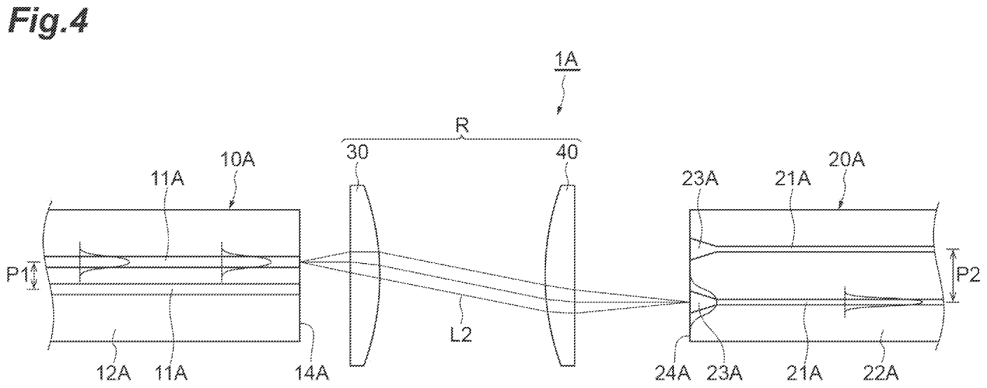

FIG. 4 is a diagram showing a multi-core fiber module 1A according to another embodiment. Hereinafter, description common to multi-core fiber module 1 described above will be omitted as appropriate. In multi-core fiber module 1A, a transmission MCF 10A having narrow core interval P1 and a connection MCF 20A having a relatively wide core interval P2 are connected to each other via relay lens system R. Transmission MCF 10A includes a core 11A, a cladding 12A and a leading end surface 14A, and connection MCF 20A includes a core 21A, a cladding 22A and a leading end surface 24A.

In multi-core fiber module 1A, core interval P1 of cores 11A of transmission MCF 10A is smaller than core interval P2 of cores 21A of connection MCF 20A. Connection MCF 20A has a core expansion portion 23A at leading end surface 24A. Core 21A at leading end surface 24A of connection MCF 20A is expanded such that a ratio between core interval P2 and the MFD2 of connection MCF 20A is equal to a ratio between core interval P1 and the MFD1 of transmission MCF 10A.

For example, a light L2 emitted from core 11A of transmission MCF 10 is condensed to core 21A of connection MCF 20A via relay lens system R. In this case, transmission MCF 10 is the input-side optical waveguide assembly and connection MCF 20A is the output optical waveguide assembly. As in the case of multi-core fiber module 1 described above, the relay magnification r of relay lens system R is equal to the ratio of core interval P2 of connection MCF 20 to core interval P1 of transmission MCF 10. In multi-core fiber module 1A, the ratio is larger than that of multi-core fiber module 1.

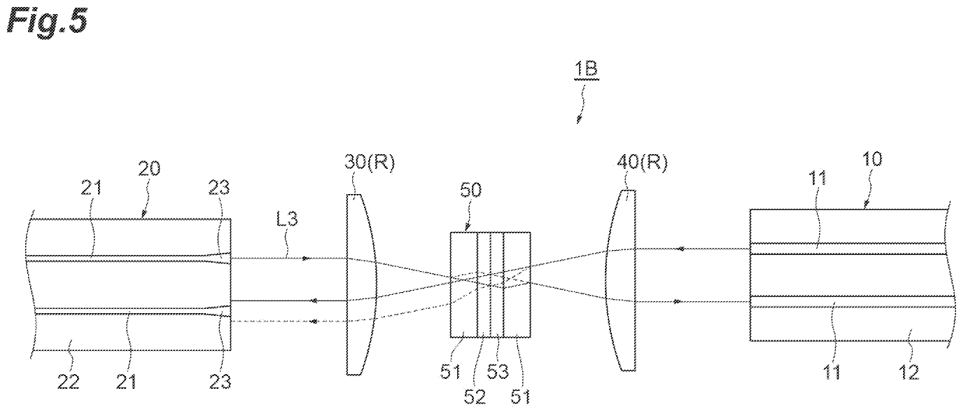

FIG. 5 is a diagram showing a multi-core fiber module 1B according to another embodiment. In multi-core fiber module 1B, an optical function element 50 (or an optical function element group) is arranged in a region including a confocal point of relay lens system R. For example, optical function element 50 includes a birefringent crystal 51, a faraday rotator 52, and a half-wave plate 53 arranged at a confocal portion of relay lens system R.

Faraday rotator 52 and half-wave plate 53 are sandwiched between a pair of birefringent crystals 51, for example. In addition, optical function element 50 may be an optical isolator. A light L3 of FIG. 3 represents a principal ray in multi-core fiber module 1B, and the dashed line of FIG. 3 represents an example of extraordinary ray. Multi-core fiber module 1B is arranged, for example, on an output side of an optical amplifier (MC-EDF) to be described in detail later.

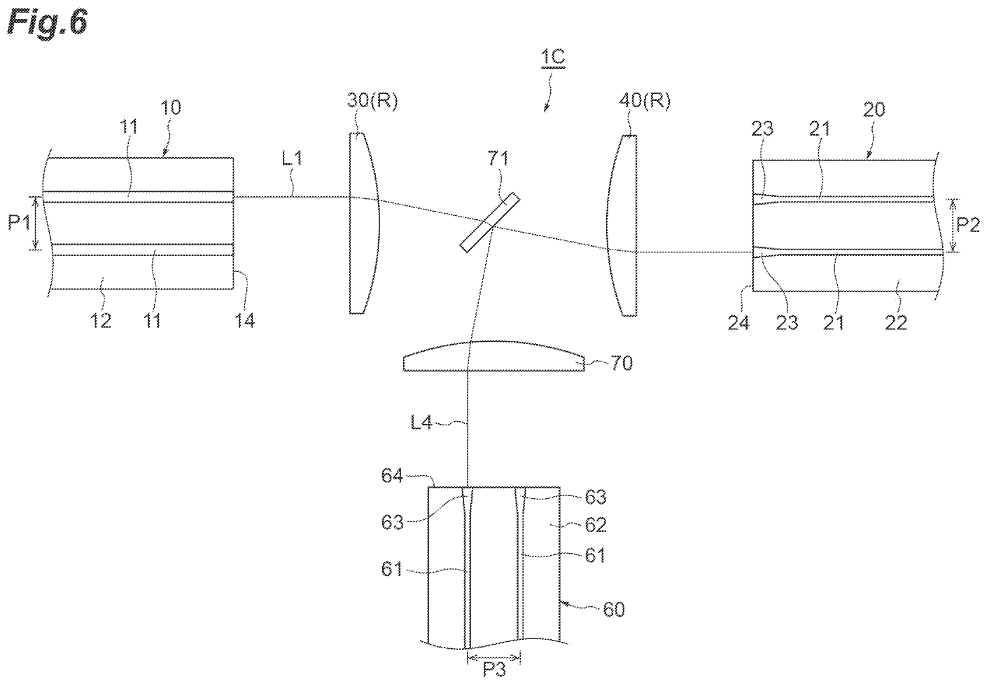

FIG. 6 shows a multi-core fiber module 1C in which a dichroic minor 71 is disposed at the confocal portion of relay lens system R and an excitation multi-core fiber (excitation MCF) 60 is connected to connection MCF 20 through dichroic minor 71. Excitation MCF 60 includes a core 61 having a core expansion portion 63 at a leading end surface 64 and a cladding 62. Excitation MCF 60 is, for example, an MCF of the same type as connection MCF 20.

Excitation MCF 60 has a core arrangement similar to the core arrangement of connection MCF 20. In addition, a relay magnification of the relay lens system including a lens 70, dichroic mirror 71, and second lens 40 located between excitation MCF 60 and connection MCF 20 and an expansion ratio of core 61 in core expansion portion 63 are determined from a relationship between a core interval P3 of core 61 of excitation MCF 60 and an MFD3 that is an MFD of core 61, as described above. Therefore, the relay magnification of the relay lens system is equal to a ratio of core interval P3 of excitation MCF 60 to core interval P2 of connection MCF 20. A ratio of core interval P3 to MFD3 of excitation MCF 60 is equal to the ratio of core interval P2 to MFD2 of connection MCF 20.

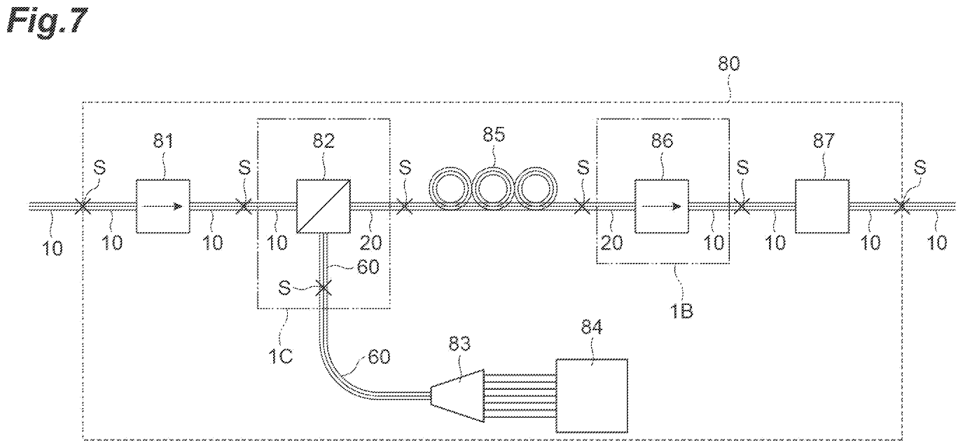

FIG. 7 shows a multi-core fiber amplifier 80 according to an embodiment. Multi-core fiber amplifier 80 includes the above-described transmission MCF 10 and connection MCF 20, an optical isolator 81, an excitation light combiner 82, a rare-earth element-doped MCF 85, an optical isolator 86, and a gain flattening filter 87.

Multi-core fiber amplifier 80 includes a plurality of transmission MCFs 10, a plurality of connection MCFs 20, a plurality of excitation MCFs 60, and a plurality of splicing points S. Splicing point S is provided at each of a boundary between a pair of transmission MCFs 10, a boundary between a pair of excitation MCFs 60, and a boundary between connection MCF 20 and rare-earth element-doped MCF 85.

Multi-core fiber amplifier 80 includes, for example, multi-core fiber module 1C (first multi-core fiber module) including transmission MCF 10, connection MCF 20 and excitation MCF 60, multi-core fiber module 1B (second multi-core fiber module), and rare-earth element-doped MCF 85.

Rare-earth element-doped MCF 85 is connected to connection MCF 20 of multi-core fiber module 1C and connection MCF 20 of multi-core fiber module 1B. Transmission MCF 10 on the signal input side is connected to transmission MCF 10 of multi-core fiber module 1C, and transmission MCF 10 on the signal output side is connected to transmission MCF 10 of multi-core fiber module 1B.

For example, multi-core fiber module 1C may include excitation light combiner 82, and multi-core fiber module 1B may include optical isolator 86. Optical isolator 81 is connected to transmission MCF 10 on the signal input side, and is connected to excitation light combiner 82 via transmission MCF 10. Transmission MCF 10 is connected to both the signal input side and the signal output side of optical isolator 81. Connection MCF 20 is connected to the signal input side of optical isolator 86, and transmission MCF 10 is connected to the signal output side of optical isolator 86.

For example, excitation light combiner 82 is connected to an excitation light output portion 83 and a driver 84 via excitation MCF 60. The signal light output from excitation light combiner 82 via connection MCF 20 and the excitation light are input to rare-earth element-doped MCF 85. A plurality of cores of rare-earth element-doped MCF 85 have a core arrangement similar to transmission MCF 10, connection MCF 20, and excitation MCF 60.

For example, rare-earth element-doped MCF 85 may collectively excite signal lights passing through a plurality of cores and collectively amplify the signal lights. Rare-earth element-doped MCF 85 may constitute, for example, a multi-core erbium (Er)-doped optical fiber amplifier (coupled amplifier) doped with erbium (Er). In this case, rare-earth element-doped MCF 85 has a plurality of cores doped with Er and a cladding surrounding the plurality of cores. When the excitation light and the signal light are input to rare-earth element-doped MCF 85, for example, the Er element doped in the core of rare-earth element-doped MCF 85 is excited and the signal light is amplified.

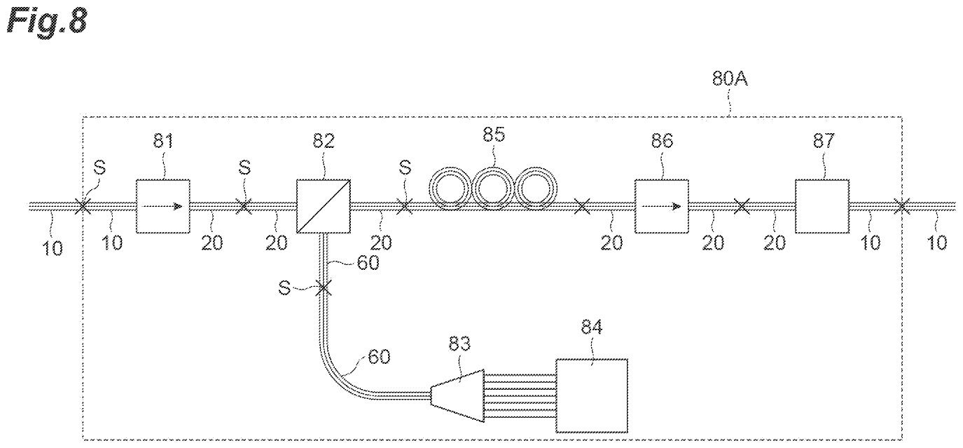

FIG. 8 shows a multi-core fiber amplifier 80A according to another embodiment. Multi-core fiber amplifier 80A is different from the above-described multi-core fiber amplifier 80 in that transmission MCF 10 is connected to the signal input side of optical isolator 81 and connection MCF 20 is connected to the signal output side of optical isolator 81. Multi-core fiber amplifier 80A is also different from multi-core fiber amplifier 80 in that connection MCF 20 is connected to both the signal input side and the signal output side of optical isolator 86.

Next, effects obtained from the multi-core fiber module and the multi-core fiber amplifier according to the embodiment will be described. In multi-core fiber module 1, the core arrangement of transmission MCF 10 is similar to the core arrangement of connection MCF 20 connected to transmission MCF 10 via relay lens system R. Relay magnification r of relay lens system R is equal to the ratio of core interval P2 of connection MCF 20 to core interval P1 of transmission MCF 10. Core 21 of leading end surface 24 of connection MCF 20 is expanded so that the ratio between core interval P2 and MFD2 of connection MCF 20 is equal to the ratio between core interval P1 and MFD1 of transmission MCF 10. Therefore, the ratios of core intervals P1 and P2 and MFD1 and MFD2 are matched between transmission MCF 10 and connection MCF 20, and the ratio of core interval P1 of transmission MCF 10 and core interval P2 of connection MCF 20 is equal to relay magnification r. Therefore, transmission MCF 10 and connection MCF 20 can be connected with low loss via relay lens system R.

Relay magnification r may be 0.5 times or more and 2.0 times or less. In this case, since relay magnification r is 0.5 times or more and 2.0 times or less, it is possible to suppress the occurrence of aberration of relay lens system R between transmission MCF 10 and connection MCF 20.

MFD2 at leading end surface 24 of connection MCF 20 may be 7 μm or more. In this case, since the MFD2 at leading end surface 24 of connection MCF 20 is 7 μm or more, the connection loss due to the reflection of light at leading end surface 24 can be more reliably suppressed.

Multi-core fiber amplifier 80 includes multi-core fiber module 1C, multi-core fiber module 1B, and rare-earth element-doped MCF 85. Rare-earth element-doped MCF 85 is connected to connection MCF 20 of multi-core fiber module 1C and connection MCF 20 of multi-core fiber module 1B. Transmission MCF 10 on the signal input side is connected to transmission MCF 10 of multi-core fiber module 1C, and transmission MCF 10 for signal output is connected to transmission MCF 10 of multi-core fiber module 1B. Core intervals P1, P2 and MFD1, MFD2 are matched between each transmission MCF 10 and each connection MCF 20, and the ratio of core intervals P1, P2 in each transmission MCF 10 and each connection MCF 20 coincides with relay magnification r. Therefore, the MFDs of transmission MCF 10 and rare-earth element-doped MCF 85 can be matched.

Multi-core fiber module 1C may include excitation light combiner 82, and multi-core fiber module 1B may include optical isolator 86. In this case, since core intervals P1, P2 and MFD1, MFD2 of respective transmission MCF 10 and connection MCF 20 are matched, it is possible to suppress the end face reflection in the optical connection via rare-earth element-doped MCF 85 or connection MCF 20 having a small MFD. In addition, it is possible to increase the utilization efficiency of the excitation light output from excitation MCF 60.

The embodiments of the multi-core fiber module and the multi-core fiber amplifier according to the present disclosure have been described above. However, the multi-core fiber module and the multi-core fiber amplifier according to the present disclosure are not limited to the above-described embodiments and can be appropriately modified. Hereinafter, further modification of the multi-core fiber module will be described.

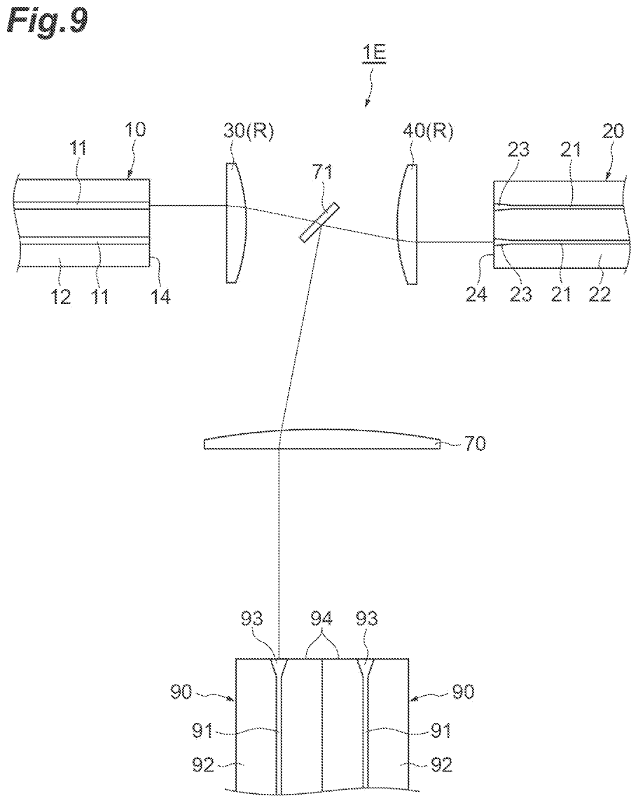

As shown in FIG. 9, a multi-core fiber module 1E according to a modification is different from multi-core fiber module 1C of FIG. 6 in that a plurality of excitation single-core fibers (excitation SCFs) 90 are provided instead of excitation MCF 60. Each excitation SCF 90 includes a core 91, a cladding 92, a core expansion portion 93 and a leading end surface 94, similar to core 61, cladding 62, core expansion portion 63 and leading end surface 64 of excitation MCF 60. In this way, the configuration of the excitation light combiner that outputs excitation light can be changed as appropriate.

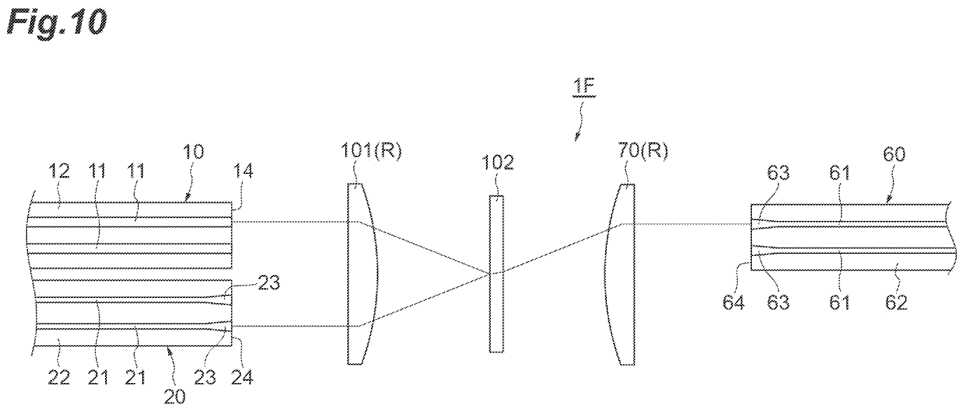

As shown in FIG. 10, a multi-core fiber module 1F according to another modification includes lens 70 and a lens 101 as relay lens system R and a dichroic minor 102. Dichroic minor 102 reflects the light input from core 11 of transmission MCF 10 via lens 101 and transmits the excitation light input from core 61 of excitation MCF 60 via lens 70. Dichroic minor 102 inputs the signal light from transmission MCF 10 and the excitation light from excitation MCF 60 to connection MCF 20 via lens 101.

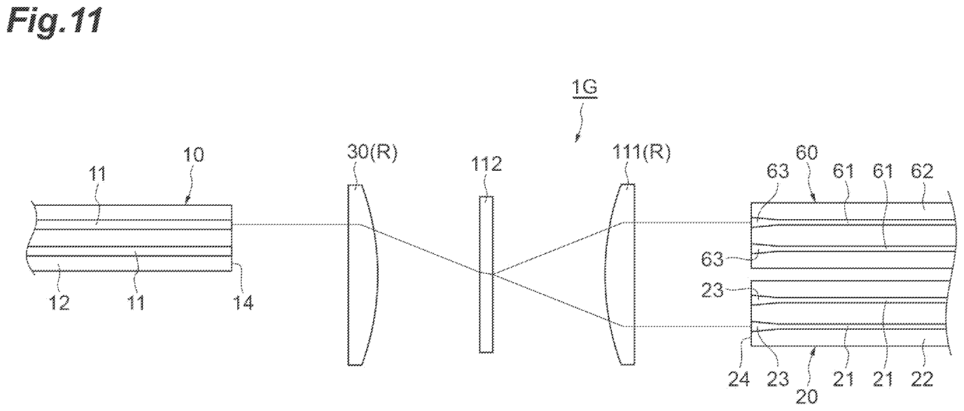

As shown in FIG. 11, a multi-core fiber module 1G according to a further modification includes first lens 30 and a lens 111 as relay lens system R and a dichroic minor 112. Dichroic minor 112 transmits the light input from core 11 of transmission MCF 10 through first lens 30 and reflects the excitation light input from core 61 of excitation MCF 60 through lens 111. Dichroic minor 112 inputs the signal light from first lens 30 to connection MCF 20 via lens 111 together with the excitation light from excitation MCF 60.

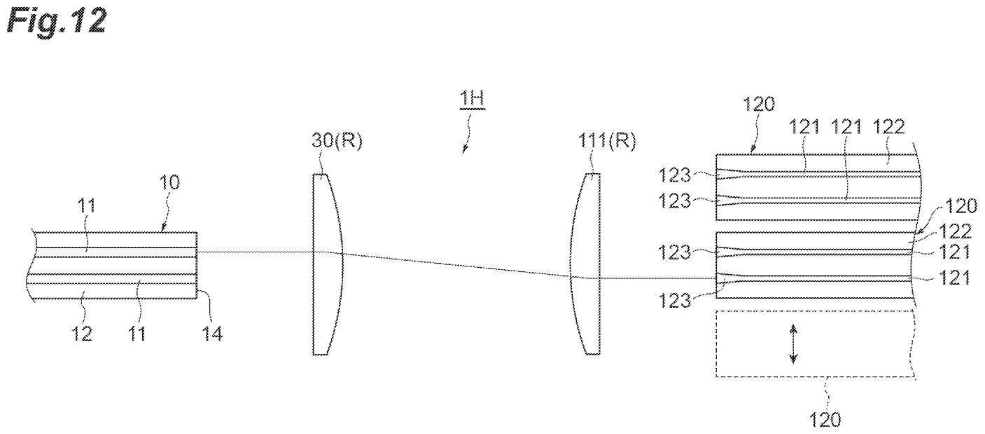

As shown in FIG. 12, a multi-core fiber module 1H according to a modification includes first lens 30 which is an input-side lens of relay lens system R and lens 111 which is an output-side lens of relay lens system R. Further, multi-core fiber module 1H has a plurality of multi-core fibers 120 which are bundled and disposed on the output side of lens 111. In this case, transmission MCF 10 is the input-side optical waveguide assembly, and the plurality of bundled multi-core fibers 120 which are bundled is the output optical waveguide assembly. Like the above-described multi-core fibers, multi-core fiber 120 includes a core 121 and a cladding 122. For example, a core expansion portion 123 is formed on an end surface of each core 21 on lens 111 side. The plurality of multi-core fibers 120 are slidable in a direction orthogonal to the optical axis. Multi-core fiber module 1H has an optical system as an optical switch for switching connection by sliding the bundled multi-core fiber 120.

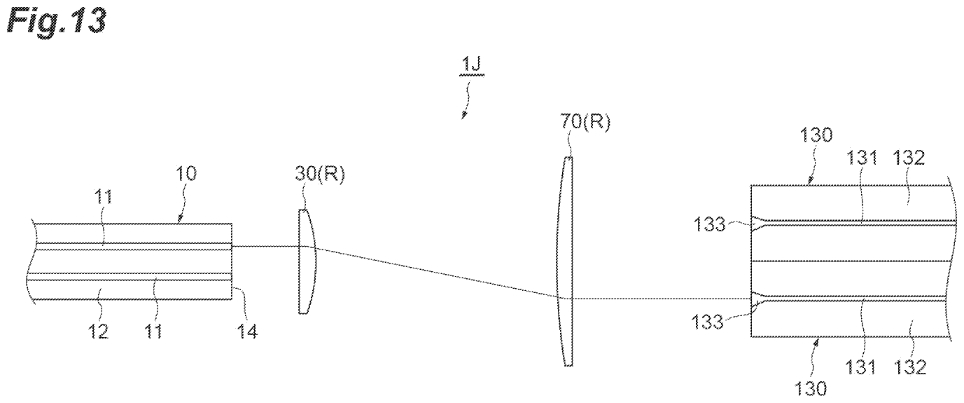

As shown in FIG. 13, a multi-core fiber module 1J according to a modification has a fan-in fan-out optical system. Multi-core fiber module 1J includes the above-described transmission MCF 10, first lens 30 which is an input-side lens of relay lens system R, lens 70 which is an output-side lens of relay lens system R, and a plurality of single-core fibers 130. For example, the plurality of single-core fibers 130 which are bundled may be provided on the output side of lens 70. Single-core fiber 130 includes a core 131 and a cladding 132, and a core expansion portion 133 is formed on an end surface of core 131 on lens 70 side. In this case, transmission MCF 10 is the input-side optical waveguide assembly, and the plurality of bundled single-core fibers 130 is the output optical waveguide assembly.

Various examples of the multi-core fiber module have been described above. In each of the above-described examples, the core expansion portion may be formed on the lens-side end surface of the core. FIG. 14 is a graph showing a relationship between a heating time of a core of an optical fiber and a mode field diameter of the optical fiber. As shown in FIG. 14, the longer the heating time of the core of the optical fiber is, the larger the mode field diameter of the optical fiber can be made.

As described above, in the multi-core fiber module according to the embodiment of the present disclosure, the coma aberration of the output side of relay lens system R is non-negative. Therefore, even if the coma aberration occurs on the output side of relay lens system R, the core aberration can be directed outward. Therefore, optical coupling to an adjacent core can be avoided, and occurrence of excessive crosstalk can be suppressed.

The coma aberration will be described in detail. First, when a radius of a circle formed by the coma aberration is R_{c}, R_{c} is expressed by Equation (1).

$$[ Equation 1 ]$$

$${R}_{C} = \frac{H {ρ}^{2}}{{f}^{3}} C \qquad ( 1 )$$

Where H is a distance from the optical axis to a ray of light on an image plane, p is a distance from the optical axis to a ray of light on a pupil plane, and f is the focal distance of the lens. C is a coma coefficient expressed by Equation (2), and when the value of C is positive, the outward coma aberration occurs, and when the value of C is negative, the inward coma aberration occurs.

$$[ Equation 2 ]$$

$$C = \frac{3 ( 2 n + 1 )}{4 n} \frac{{S}_{1} - {S}_{0}}{{S}_{1} + {S}_{0}} + \frac{3 ( n + 1 )}{4 n ( n - 1 )} \frac{{r}_{2} - {r}_{1}}{{r}_{2} + {r}_{1}} \qquad ( 2 )$$

Here, n represents a refractive index of a glass material of a lens, S₁ represents a distance between the image plane and the pupil plane, S₀ represents a distance between the object plane and the pupil plane, r₁ represents a radius of curvature of an object-side surface of the lens, and r₂ represents a radius of curvature of an image-side surface of the lens. In Equation (2), when one of the absolute values of r₁ and r₂ is extremely large as in the plano-convex lens, it is difficult to distinguish the convex surface, the concave surface, and the flat surface. In the scale of the spatial optical module for multi-core fiber, when the radius of curvature exceeds the 100 mm, even the convex surface or the concave surface cannot be distinguished from the flat surface.

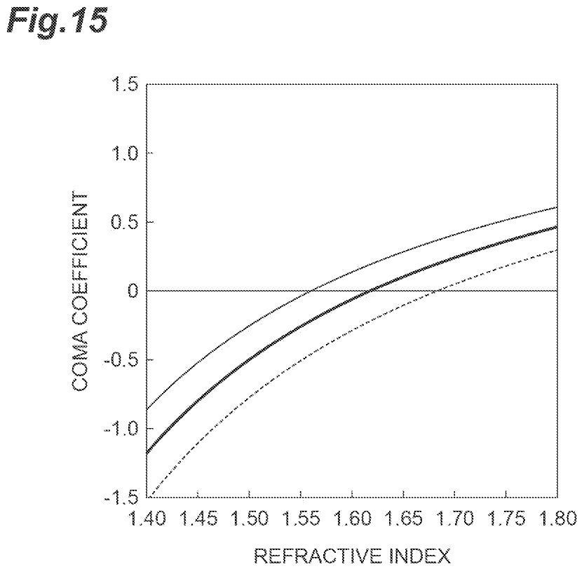

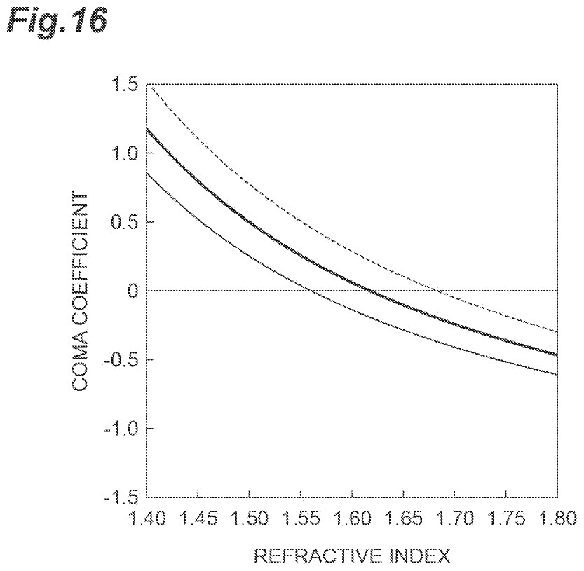

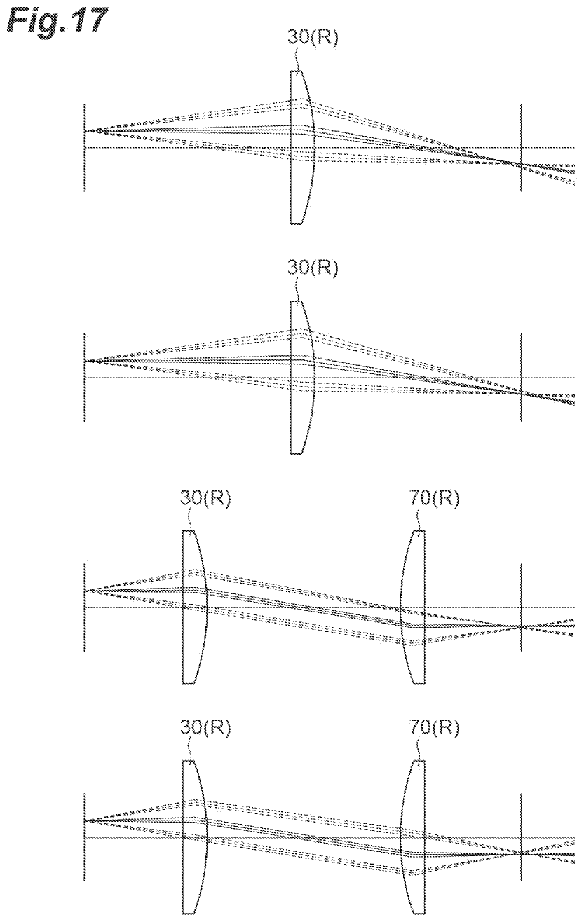

FIG. 15 is a graph showing the relationship between a coma coefficient and a refractive index when a parallel light is emitted from a plane in a plano-convex lens. FIG. 16 is a graph showing a relationship between a coma coefficient and a refractive index when a parallel light is incident on a plane in a plano-convex lens. FIG. 17 shows various examples of ray of light when a coma aberration occurs. The uppermost row of FIG. 17 shows the case where the outward coma aberration occurs in an unit conjugated system, the second row from the top of FIG. 17 shows the case where the inward coma aberration occurs in the unit conjugated system, the third row from the top of FIG. 17 shows the case where the outward coma aberration occurs in a relay system, and the first row from the bottom of FIG. 17 shows the case where the inward coma aberration occurs in the relay system. In the embodiment, excessive crosstalk can be suppressed by adjusting the lens so that the coma aberration that occurs is outward.

Various examples of the multi-core fiber module and the multi-core fiber amplifier have been described above. However, the multi-core fiber module and the multi-core fiber amplifier according to the present disclosure are not limited to the above-described examples. That is, it is easily recognized by those skilled in the art that various modifications and changes can be made to the present invention within the scope of the gist described in the claims. For example, the configuration, function, material, and arrangement mode of each part of the multi-core fiber module and the multi-core fiber amplifier can be appropriately changed within the scope of the gist described above.

### REFERENCE SIGNS LIST

1, 1A multi-core fiber module
1B multi-core fiber module (second multi-core fiber module)
1C multi-core fiber module (first multi-core fiber module)
1E, 1F, 1G multi-core fiber module
10, 10A transmission MCF
11, 11A, 21, 21A core
12, 12A, 22, 22A cladding
14, 14A leading end surface
20, 20A connection MCF
23, 23A core expansion portion
24, 24A leading end surface
30 first lens
40 second lens
50 optical function element
51 birefringent crystal
52 Faraday rotator
53 half-wave plate
60, 90 excitation multi-core fiber (excitation MCF)
61, 91 core
62, 92 cladding
63, 93 core expansion portion
64 leading end surface
70 lens
71 dichroic minor
80, 80A multi-core fiber amplifier
81 optical isolator
82 excitation light combiner
83 excitation light output portion
84 driver
85 rare-earth element-doped MCF
86 optical isolator
87 gain flattening filter
101, 111 lens
102, 112 dichroic minor
120 multi-core fiber
121, 131 core
122, 132 cladding
123, 133 core expansion portion
130 single-core fiber
L1, L2, L3 light
P1, P2, P3 core interval
R relay lens system
r relay magnification
S splicing point

1. A multi-core fiber module comprising:
a transmission optical waveguide assembly configured to be used as a transmission path for an optical signal;
a connection optical waveguide assembly having a core arrangement similar to a core arrangement of a core of the transmission optical waveguide assembly; and
a relay lens system interposed between the transmission optical waveguide assembly and the connection optical waveguide assembly,
wherein a relay magnification of the relay lens system is equal to a ratio of a core interval of the connection optical waveguide assembly to a core interval of the transmission optical waveguide assembly,
wherein a core at a leading end surface of the connection optical waveguide assembly is expanded such that a ratio between the core interval and a mode field diameter of the connection optical waveguide assembly is equal to a ratio between the core interval and a mode field diameter of the transmission optical waveguide assembly, and
wherein at least one of the transmission optical waveguide assembly and the connection optical waveguide assembly is a multi-core fiber.

2. The multi-core fiber module according to claim 1,
wherein both the transmission optical waveguide assembly and the connection optical waveguide assembly are multi-core fibers.

3. The multi-core fiber module according to claim 1,
wherein the relay magnification is 0.5 times or more and 2.0 times or less.

4. The multi-core fiber module according to claim 1,
wherein the mode field diameter at the leading end surface of the connection optical waveguide assembly is 7 μm or more.

5. The multi-core fiber module according to claim 1,
wherein a coma aberration on an output side of the relay lens system is non-negative.

6. The multi-core fiber module according to claim 1,
wherein one of the transmission optical waveguide assembly and the connection optical waveguide assembly is an input-side optical waveguide assembly, and another one of the transmission optical waveguide assembly and the connection optical waveguide assembly is an output optical waveguide assembly,
wherein the relay lens system includes an input-side lens and an output-side lens,
wherein a refractive index of the input-side lens is 1.68 or more, and a radius of curvature of an incidence surface of the input-side lens is 10 times or more of a radius of curvature of an exit surface of the input-side lens,
wherein the input-side optical waveguide assembly is disposed such that a distance between a light exit end of the input-side optical waveguide assembly and a principal point of the input-side lens is 0.99 times or more and 1.01 times or less of a focal distance of the input-side lens,
wherein a refractive index of the output-side lens is 1.70 or less, and a radius of curvature of an exit surface of the output-side lens is 10 times or more of a radius of curvature of an incidence surface of the output-side lens, and
wherein the output optical waveguide assembly is disposed such that a distance between a light incidence end of the output optical waveguide assembly and a principal point of the output-side lens is 0.99 times or more and 1.01 times or less of a focal distance of the output-side lens.

7. The multi-core fiber module according to claim 1,
wherein one of the transmission optical waveguide assembly and the connection optical waveguide assembly is an input-side optical waveguide assembly, and another one of the transmission optical waveguide assembly and the connection optical waveguide assembly is an output optical waveguide assembly,
wherein the relay lens system includes an input-side lens and an output-side lens,
wherein a refractive index of the input-side lens is 1.62 or more, and a radius of curvature of an incidence surface of the input-side lens is 10 times or more of a radius of curvature of an exit surface of the input-side lens,
wherein the input-side optical waveguide assembly is disposed such that a distance between a light exit end of the input-side optical waveguide assembly and a principal point of the input-side lens is 0.99 times or more and 1.01 times or less of a focal distance of the input-side lens,
wherein a refractive index of the output-side lens is 1.51 or less, and a radius of curvature of an exit surface of the output-side lens is 10 times or more of a radius of curvature of an incidence surface of the output-side lens, and
wherein the output optical waveguide assembly is disposed such that a distance between a light incidence end of the output optical waveguide assembly and a principal point of the output-side lens is 0.99 times or more and 1.01 times or less of a focal distance of the output-side lens.

8. A multi-core fiber module comprising:
a transmission optical waveguide assembly configured to be used as a transmission path for an optical signal;
a connection optical waveguide assembly having a core arrangement similar to a core arrangement of a core of the transmission optical waveguide assembly; and
a relay lens system interposed between the transmission optical waveguide assembly and the connection optical waveguide assembly,
wherein a relay magnification of the relay lens system is equal to a ratio of a core interval of the connection optical waveguide assembly to a core interval of the transmission optical waveguide assembly,
wherein a coma aberration on an output side of the relay lens system is non-negative, and
wherein at least one of the transmission optical waveguide assembly and the connection optical waveguide assembly is a multi-core fiber.

9. The multi-core fiber module according to claim 8,
wherein one of the transmission optical waveguide assembly and the connection optical waveguide assembly is an input-side optical waveguide assembly, and another one of the transmission optical waveguide assembly and the connection optical waveguide assembly is an output optical waveguide assembly,
wherein the relay lens system includes an input-side lens and an output-side lens,
wherein a refractive index of the input-side lens is 1.68 or more, and a radius of curvature of an incidence surface of the input-side lens is 10 times or more of a radius of curvature of an exit surface of the input-side lens,
wherein the input-side optical waveguide assembly is disposed such that a distance between a light exit end of the input-side optical waveguide assembly and a principal point of the input-side lens is 0.99 times or more and 1.01 times or less of a focal distance of the input-side lens,
wherein a refractive index of the output-side lens is 1.70 or less, and a radius of curvature of an exit surface of the output-side lens is 10 times or more of a radius of curvature of an incidence surface of the output-side lens, and
wherein the output optical waveguide assembly is disposed such that a distance between a light incidence end of the output optical waveguide assembly and a principal point of the output-side lens is 0.99 times or more and 1.01 times or less of a focal distance of the output-side lens.

10. The multi-core fiber module according to claim 8,
wherein one of the transmission optical waveguide assembly and the connection optical waveguide assembly is an input-side optical waveguide assembly, and another one of the transmission optical waveguide assembly and the connection optical waveguide assembly is an output optical waveguide assembly,
wherein the relay lens system includes an input-side lens and an output-side lens,
wherein a refractive index of the input-side lens is 1.62 or more, and a radius of curvature of an incidence surface of the input-side lens is 10 times or more of a radius of curvature of an exit surface of the input-side lens,
wherein the input-side optical waveguide assembly is disposed such that a distance between a light exit end of the input-side optical waveguide assembly and a principal point of the input-side lens is 0.99 times or more and 1.01 times or less of a focal distance of the input-side lens,
wherein a refractive index of the output-side lens is 1.51 or less, and a radius of curvature of an exit surface of the output-side lens is 10 times or more of a radius of curvature of an incidence surface of the output-side lens, and
wherein the output optical waveguide assembly is disposed such that a distance between a light incidence end of the output optical waveguide assembly and a principal point of the output-side lens is 0.99 times or more and 1.01 times or less of a focal distance of the output-side lens.

11. The multi-core fiber module according to claim 8,
wherein a core at a leading end surface of an optical waveguide of at least one of the transmission optical waveguide assembly and the connection optical waveguide assembly is expanded.

12. The multi-core fiber module according to claim 1,
wherein the transmission optical waveguide assembly and the connection optical waveguide assembly are multi-core fibers of types identical to each other.

13. The multi-core fiber module according to claim 1,
wherein the transmission optical waveguide assembly and the connection optical waveguide assembly are multi-core fibers of types differing from each other.

14. The multi-core fiber module according to claim 1,
wherein one of the transmission optical waveguide assembly and the connection optical waveguide assembly is an assembly of single-core fibers.

15. The multi-core fiber module according to claim 1,
wherein at least one of the transmission optical waveguide assembly and the connection optical waveguide assembly is an assembly of multi-core fibers.

16. A multi-core fiber amplifier comprising the multi-core fiber module according to claim 1, and a rare-earth element-doped multi-core fiber in which the connection optical waveguide assembly is doped with a rare earth element, the multi-core fiber amplifier comprising:
the transmission optical waveguide assembly that is a first transmission optical waveguide assembly on a signal input side;
the transmission optical waveguide assembly that is a second transmission optical waveguide assembly on a signal output side;
the multi-core fiber module that is a first multi-core fiber module; and
the multi-core fiber module that is a second multi-core fiber module,
wherein the rare-earth element-doped multi-core fiber is connected to the connection optical waveguide assembly of the first multi-core fiber module and the connection optical waveguide assembly of the second multi-core fiber module,
wherein the transmission optical waveguide assembly of the first multi-core fiber module is connected to the first transmission optical waveguide assembly, and
wherein the transmission optical waveguide assembly of the second multi-core fiber module is connected to the second transmission optical waveguide assembly.

17. The multi-core fiber amplifier according to claim 16,
wherein the first multi-core fiber module includes an excitation light combiner, and
wherein the second multi-core fiber module includes an optical isolator.
